(19) United States
(12) Patent Application Publication
(10) Pub. No.: US 2010/0100487 A1
(43) Pub. Date: Apr. 22, 2010

(54) VIRTUAL WORLD CONTEST, AUCTION, ELECTION, SALES METHOD FOR NOTIFICATION AND INTERACTION WITH THE REAL WORLD

(75) Inventors: Charles S. Lingafelt, Durham, NC (US); Michael J. Martine, Chapel Hill, NC (US); Michael Rowe, Durham, NC (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/252,438

(22) Filed: Oct. 16, 2008

(51) Int. Cl. G06Q 99/00

(52) U.S. Cl. 705/80; 705/12; 705/319

(57) ABSTRACT

A method and system for conducting contests, auctions, elections, or sales are disclosed. A user in a real world can participate in an event in a virtual world without knowing the event occurs in the virtual world. Information related to the event is first transmitted from the virtual world to the real world in accordance with an inter-world protocol. In the real world, the information is broadcasted via a communication channel. A user in the real world provides a feedback for the event by calling or text messaging. The feedback from the user is transmitted from the real world to the virtual world. The feedback is collected in the real world or in the virtual world. Based on the number of feedbacks, a winner is selected in the event in the virtual world. The winner is also informed to the real world in accordance with the inter-world protocol.

### BACKGROUND OF THE INVENTION

1. Field of the Invention

The present invention generally relates to a virtual world environment. More particularly, the present invention relates to conducting contests, auctions, elections, or sales in a virtual world with interaction with people in a real world.

2. Description of the Prior Art

A virtual world is a computer-based simulated environment where avatars (i.e., a virtual representation of a user) inhabit and interact with other avatars. In a virtual world (e.g., Active Worlds™), a human projects himself/herself into the virtual world in the form of an actor (e.g., a motional avatar) that can interact within the virtual world. Examples of virtual worlds include, but is not limited to, Second Life®, There, Eve Online and others such as Metaverse (e.g., a virtual world where humans interact with each other and software applications in three dimensional space that uses a metaphor of a real world) and MMORPGs (Massively Multiplayer Online Role-Playing Games) environments.

A real world is a physical reality of every day life which humans experience. In a real world, contestants may compete to be cast as a main character of a Broadway musical. The contest can be broadcasted over TV and the contestants sing and dance to win the contest. TV audiences provide feedback (e.g., a vote), using, for example, a telephone to dial a number that corresponds to their choices among contestants, to participate a vote to select a winner who is going to be main character of the Broadway musical

Similar events can be conducted in a virtual world, such as an avatar beauty Pageant show, an art shows, etc. However, in the current existing technology, the contests in the virtual world seek a participation of an audience only in that virtual world. To accommodate wider audiences extended to the virtual world, e.g., including a real world audience, a service that can support interaction between the virtual world and the real world is needed.

Therefore, it would be desirable to provide a system and method for conducting interactive events in a virtual world such as but not limited to: contests, auctions, elections, or sales in a virtual world including an interaction with and participation of people outside the virtual world environment.

### SUMMARY OF THE INVENTION

It is therefore an object of the present invention to provide a method, system, computer program product, and computer program storage device for conducting interactive events such as contests, auctions, elections, or sales in a virtual world with participants extend to the virtual world environment, i.e., interaction with people in a real world.

In one embodiment, there is provided a method for conducting an event requiring a user participation in a virtual world environment with an interaction by real world participants comprising:
determining an event structure in a virtual world;
identifying at least one information object that can be voted based on the event structure;
creating an information store comprising one or more of: association of an information object with a respective counter and an object correlator assigned to the information object;
sending the at least one information object and corresponding object correlators from the virtual world to the real world;
receiving the at least one information object and the corresponding object correlator in the real world;
broadcasting the at least one information object along with a feedback method;
receiving a feedback from a real world participant via the feedback method, the feedback being associated with an information object among the at least one information object;
sending a count value recorded by the counter in response to the feedback along with a corresponding object correlator from the real world to the virtual world;
receiving the count value and the corresponding object correlator in the virtual world;
associating the count value with an information object by using the corresponding object correlator; and
determining a winner based on a total count value.

In another embodiment, there is provided a system for conducting an event requiring a user participation in a virtual world environment with an interaction by real world participants comprising:
means for determining a event structure in a virtual world;
means for identifying at least one information object that can be voted based on the event structure;
means for creating an information store comprising one or more of: association of an information object with a respective counter and an object correlator assigned to the information object;
means for sending the at least one information object and corresponding object correlator from the virtual world to the real world;
means for receiving the at least one information object and the corresponding object correlator in the real world;
means for broadcasting the at least one information object along with a feedback method;
means for receiving a feedback from a real world participant via the feedback method, the feedback being associated with an information object among the at least one information object;
means for sending a count value recorded by the counter in response to the feedback along with a corresponding object correlator from the real world to the virtual world;
means for receiving the count value and the corresponding object correlator in the virtual world;
means for associating the count value with an information object by using the corresponding object correlator; and
means for determining a winner based on a total count value.

There are several advantages of such a system and method including, but not limited to:
A wider audience can participate in contests, auctions, elections, or sales.
People in the real world do not have to be in the virtual world to participate in the contests, auctions, elections, or sales in the virtual worlds.
People in the real world may not be aware that the contests, auctions, elections, or sales are being conducted in a virtual world.

In another embodiment, counts (e.g., vote counts) that are collected in the real world environment may be provided from the real world to a virtual world, after events (e.g., contests, auctions, elections, or sales) in the virtual world are completed.

### BRIEF DESCRIPTION OF THE DRAWINGS

The objects, features and advantages of the present invention will become apparent to one ordinary skill in the art, in view of the following detailed description taken in combination with the attached drawings, in which:

FIG. 1A is an illustrative component diagram of one embodiment of the present invention.

FIG. 1B is an illustrative component diagram of another embodiment of the present invention.

FIG. 2 is a flow diagram illustrating method steps of one embodiment of the present invention.

FIG. 3 is a flow diagram illustrating method steps of another embodiment of the present invention.

FIG. 4 is a flow diagram illustrating method steps of one embodiment of the present invention.

### DETAILED DESCRIPTION OF THE PREFERRED EMBODIMENTS

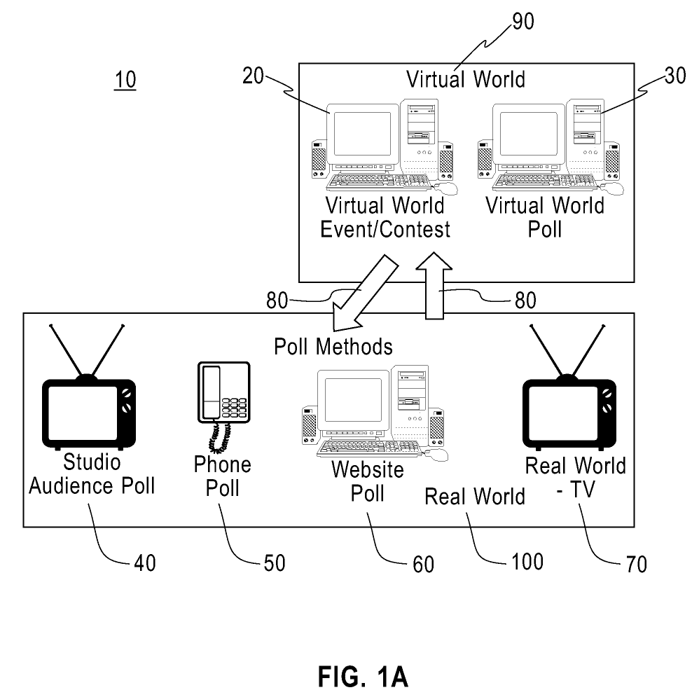

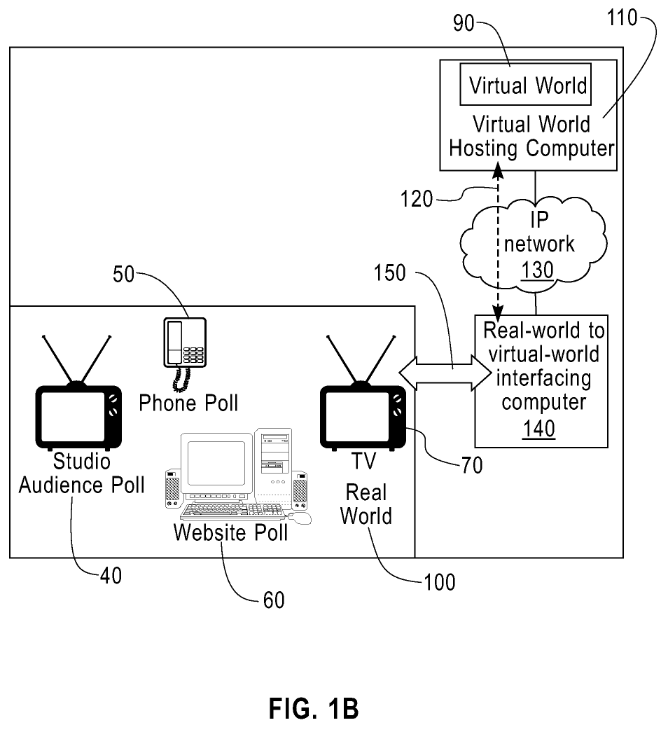

FIG. 1A depicts an illustrative component diagram of one embodiment of the present invention. In a society 10, there is a virtual world (e.g., Second Life®) 90 and a real world environment 100. In this embodiment, an event (e.g., a contest, an auction, an election, and a sale) occurs in the virtual world 90. The event is served in a hosting machine (e.g., a computer) 20 in the virtual world 90. Users (e.g., audiences) via their networked connections to the virtual world 90 can participate in the event in the virtual world 90 via a polling method (e.g., an avatar votes for a contestant in the contest) 30 in the virtual world. Users in the real world environment 100 can participate in the event in virtual world 90 via a polling method using one of many real world communication modalities (e.g., a studio audience poll (e.g., voting in a broadcasting studio as an audience) 40, a phone call 50, a website poll (i.e., a voting via a website) 60, television (e.g., voting for a contestant in the contest while watching current voting status for the contest) 70). Arrows 80 indicates information (e.g., votes or voting results) is shared between the virtual world 90 and the real world 100 via a communication link (e.g., a wireless communication link, an optical communication link, a wired communication link, a satellite communication link, or under the water communication link).

FIG. 1B depicts a mechanism for communicating between the virtual world 90 and the real world 100. In one embodiment, there is a virtual world hosting computer 110 in the virtual world 90. The virtual world hosting computer 110 may be a server equipped with programs, APIs, functions, and subroutines to operate the virtual world 90. The virtual world hosting computer 110 may store configuration and setting information of each user registered in the virtual world 90. A user who is operating a real world to virtual world interfacing computer 140 at a home or at an office can login the virtual world 90 via a network 130 such as IP (Internet Protocol) network. In one embodiment, the real world to virtual world interfacing computer 140 may be a user's personal computer operating as a client. Arrow 120 represents the virtual world hosting computer 110 in the virtual world 90 and the real world to virtual world interfacing computer 140 communicating with each other via the network 130. In one embodiment, other electronic devices (e.g., a polling device 40 in a broadcasting studio, a phone 50, a computer 60, a television 70) in real world 100 may be connected with the real world to virtual world interfacing computer 140 via a communication link 150 (e.g., a wireless communication link, an optical communication link, a wired communication link, a satellite communication link, or under the water communication link). Therefore, the electronic devices in the real world 100 can share information with the virtual world hosting computer 110 in the virtual world 90 via the real world to virtual world interfacing computer 140. In one embodiment, the real world to virtual world interfacing computer 140 is a computing device (e.g., a computer, a handheld, a mobile or laptop PC, or a two-way wrist radio) that provides data to be passed from the real world 100 to the virtual world 90.

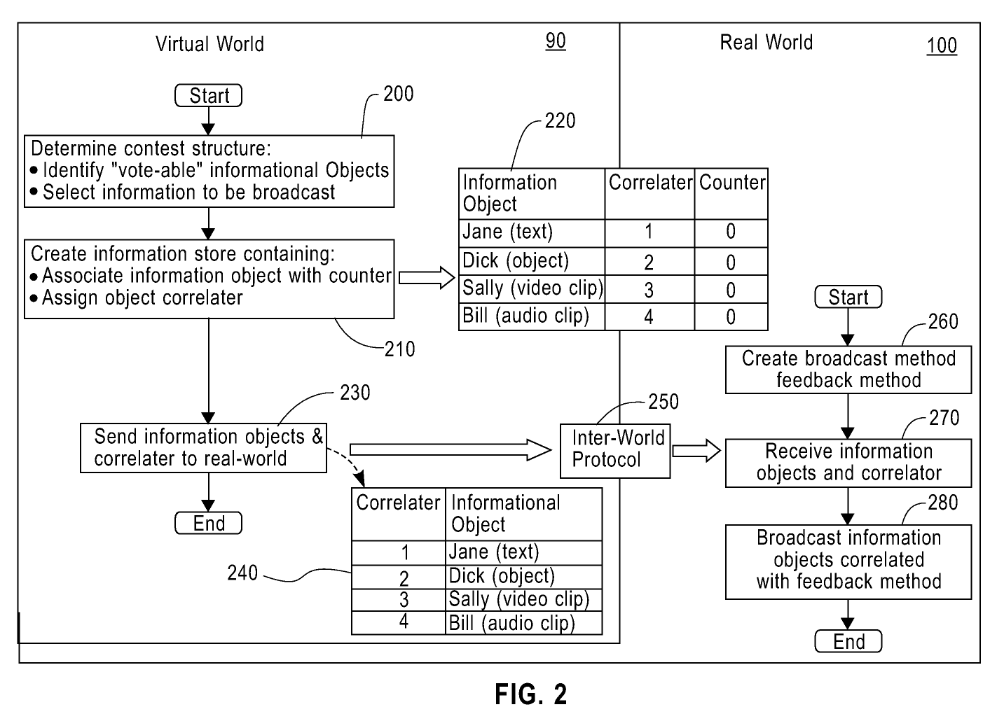

FIG. 2 depicts an event such as a contest that is conducted in a virtual world environment 90 and, as shown, includes information related to the event (e.g., a video, an audio, a numerical characterization) that are provided to a real world 100. As an event is initiated, at step 200, an event structure (e.g., a round-robin tournament) is determined. In one embodiment, “vote-able” (e.g., an object is vote-able if the object can be a subject to be voted) information objects (e.g., real world objects (e.g., a car, a house, a text file, a video clip, an audio clip) or virtual world objects (e.g., an avatar, a virtual weapon, a virtual power, a virtual authority)) are identified at step 200. Additionally, information (e.g., a video, an audio, a numerical characterization) to be broadcasted in the real world 100 may be selected. At step 210, an information store 220 is created. In one embodiment, the information store 220 is a table or database record that associates each information object with a corresponding counter (i.e., a hardware device or software-implemented method for counting the number of votes for corresponding information objects) and corresponding correlator assigned to the information object. An object correlator is a unique ID associated with an information object and used by programs (e.g., a virtual world hosting application) to reference or represent the information object. The object correlator can take many forms such as a UUID (Universally Unique Identifier), a decimal number, a URL (Uniform Resource Locator), a letter, etc. as required by a programming environment (e.g., a platform to execute programs). In one embodiment, each information object may have a counter and an object correlator.

At step 230, information objects and corresponding object correlators are sent from the virtual world 90 to the real world 100. In one embodiment, a table or database 240 is created to store pairs of information objects and corresponding object correlators in the virtual world 90 and then sent from the virtual world 90 to the real world environment 100 via a network communication link. The information objects and corresponding correlators are transmitted from the virtual world 90 to the real world 100 in accordance with an inter-world protocol 250, or via an interface provided by a virtual world service provider (e.g., moove online). The inter-world protocol 250 includes, but is not limited to: RSS (Really Simple Syndication) feeds, XML (The Extensible Markup Language)-RPC (Remote Procedure Call) protocol, TCP (Transmission Control Protocol), and UDP (User Datagram Protocol). In one embodiment, other information (e.g., an audio/visual clip, a video clip, an audio clip) related to the event (e.g., a contest) is also transmitted in accordance with the inter-world protocol 250 from the virtual world 90 to the real world 100. In one embodiment, the inter-world protocol 250 is a method of data transfer between the virtual world 90 and the real world 100. This method of data transfer can be a common data transmission protocol such as XML document, remote function calls, web services, TCP/IP, etc. A provider of the virtual world 90 specifies a protocol (e.g., RSS feeds, XML-RPC protocol, etc.) that can be used to interface between the real world 100 and the virtual world 90. Data transmission between the real world 100 and the virtual world 90 is achieved by the use of the specified protocol.

In the real world 100, at step 260, a broadcasting method (e.g., TV and cable broadcasting, real-time/live broadcasting, radio broadcasting) and a feedback method (i.e., a method that audiences or users can participate the contest; e.g., a vote) is created or established (e.g., by a broadcasting entity—e.g., a broadcaster such as a cable or TV network operator). At step 270, the information objects and corresponding object correlators are received in the real world 100. At step 280, the received information objects and the established feedback method is disseminated to users, e.g., broadcasted via communication channels (e.g., Television, Radio, Internet interactive web site, RSS (Really Simple Syndication) feeds, blogs, podcasts (i.e., a series of digital-media files which are distributed over the internet using syndication feeds for playbacks on portable media players and computers), printed media (e.g., magazines or newspapers), an interactive audience participation show). Informational objects in the information store 220 are objects of a contest. When an object is a text, the contest can be a poetry contest with people in the real world voting on which poetry is the best. Thus each poem originating in the virtual world 90 is associated with an object correlator and then the poems are broadcast in real world 100 in diverse ways. The broadcast method in the real world 100 is a radio, television, an in-person theater, etc. A feedback mechanism in the real world 100 can be a showing of hands, calling at a 1-800 numbers, etc. In one embodiment, a voting place in the real world 100 and a feedback mechanism is selected in order for a contest, an auction, an election, etc. to take place.

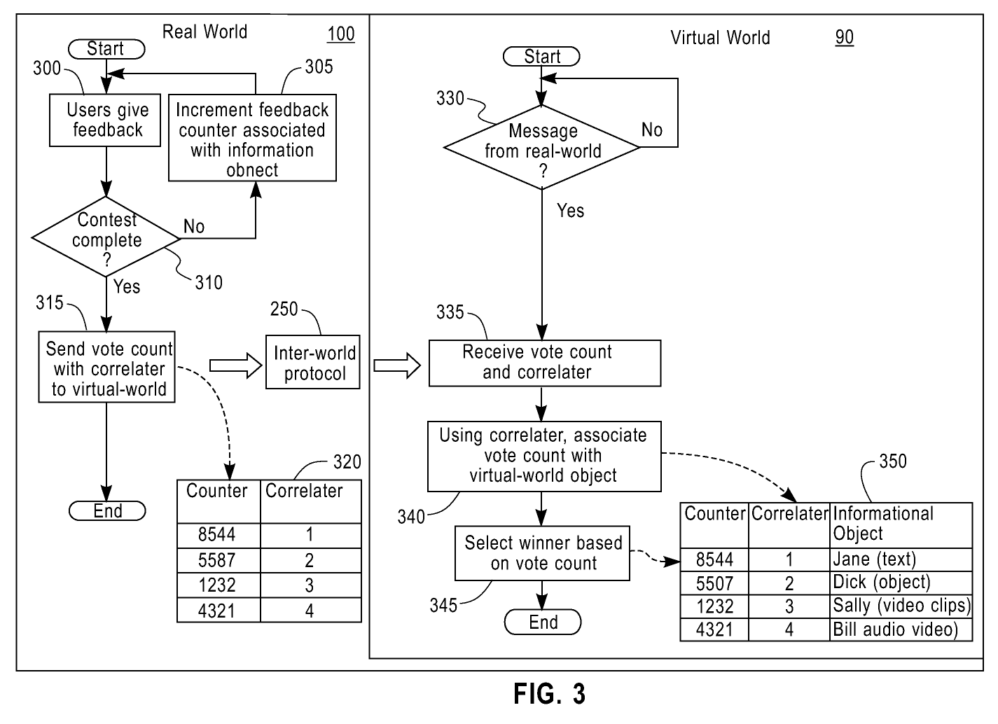

FIG. 3 illustrates counts (e.g. voting counts) are held in a real world 100 until the event (e.g., a contest) is ended, at which time information (e.g., voting counts) is transferred from the real world 100 to a virtual world 90. While watching the broadcasting or listening to the broadcast, at step 300, a user (e.g., an audience) in the real world 100 provides a feedback (e.g., a vote) (e.g., by dialing a telephone number which can be interpreted as a vote for a contestant, by going to a web site and clicking a response button to vote for a contestant, by sending a mail to vote for a contestant, by calling a contestant's name (i.e., audio response), and by joining a group who votes for a contestant (e.g., a physical movement, registering to a group, a virtual movement), by text messaging, by pushing a button on an audience response device, by showing a hand, etc.).

Upon receiving a feedback (e.g. a vote) associated with an information object via a feedback method (e.g., voting) from a user (e.g., an audience), at step 310, it is checked whether the event (e.g., a contest) is completed or not. If the event is not completed, then a counter associated with the information object is incremented at step 305. If the event is completed, count values (e.g., voting counts) and corresponding object correlators are sent from the real world 100 to the virtual world 90 in accordance with the inter-world protocol 250. In one embodiment, each counter stores a count value for a corresponding object correlator or corresponding information object received from a voting real world participant. In one embodiment, at step 315, a table or database 320 that stores pairs of counters and corresponding object correlators is created and then sent from the real world 100 to the virtual world 90 in accordance with the inter-world protocol 250.

In one embodiment, a notification is sent from the real world 100 to the virtual world 90, when an event (e.g., a contest, auction, election, or sale) is completed. In another embodiment, an event ending decision (i.e., determining whether an event is completed or not) is made in the virtual world 90. The notification is sent from the virtual world 90 to the real world 100 via the inter-world protocol 250. The notification includes, but is not limited to, a contest end message, an auction end message, an election end message, and a sale end message. The notification may be sent via an email, a mail, a fax, a text messaging, an alert, or other communication modalities etc.

By returning to FIG. 3, at step 330, whenever a message is received (e.g., at a virtual world hosting computer 110) in the virtual world 90, it is checked whether the message is from the real world environment 100. If the message is not from the real world environment 100, the message is not considered for the event. If the message is from the real world environment 100, it is further checked whether the message stores a count information (e.g., table 320). At step 335, upon receiving a message including the count information from the real world 100, count values and corresponding object correlators are retrieved from the message. At step 340, a count value is associated with an information object by using a corresponding object correlator. In one embodiment, a table or database 350 that stores relationship among each counter, each correlator, and each information object in the virtual world 90 is created. At step 345, a winner for the contest is determined based on a total count value. For example, as shown in table 350, if an information object “Jane” has the highest count value (e.g. a highest counter number), the information object “Jane” is determined as a winner. In one embodiment, upon selecting a winner in the virtual world 90, the winner is informed to the real world voting participants in accordance with the inter-world protocol 250.

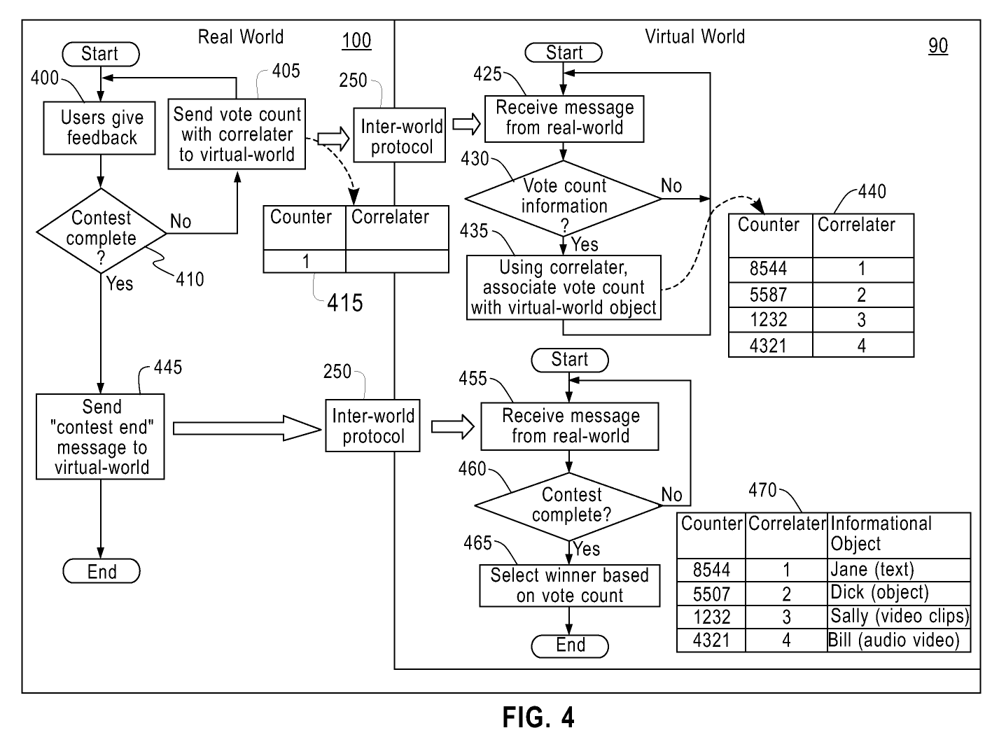

FIG. 4 illustrates that count values (e.g., voting counts) that are held in the virtual world 90 until the event (e.g., a contest) is ended. After performing step 280 (i.e., broadcasting information objects and a feedback method in the real world 100) in FIG. 2, a user in the real world 100 provides a feedback for an information object at step 400. At step 410, it is checked whether the event is completed or not. If the event is not completed, at step 405, upon receiving the feedback from a user, the feedback and a corresponding object correlator is provided from the real world 100 to the virtual world 90 in accordance with the inter-world protocol 250. In one embodiment, the number of new feedbacks and a corresponding object correlator(s) are provided from the real world 100 to the virtual world 90 in the accordance with the inter-world protocol 250. In another embodiment, a table or database 415 that stores an amount that a counter increments (e.g., the number of new feedbacks) and a corresponding object correlator is created and then provided from the real world 100 to the virtual world 90 in the accordance with the inter-world protocol 250. At step 425, a message arrives at the hosting virtual world server device of the virtual world 90 from the real world 100. At step 430, it is checked whether the message from the real world 100 includes count information (e.g., a table 415). If the message does not include the count information, the message is not further considered. If the message includes the count information, the number of new feedbacks and corresponding object correlator(s) are retrieved from the message. At step 435, an overall feedback status (e.g., 440) is updated by adding the number of new feedbacks to counters associated with the corresponding object correlators. For example, if a table 415 is received at step 425 from the real world 100 to the virtual world 90, a table 440 is updated by incrementing a current counter corresponding to its respective object correlator. In one embodiment, a table or database 440 that stores counters and corresponding object correlators are maintained in the virtual world and updated every time a new count information (e.g., table 415) is provided.

If it is determined at step 410 that the event is completed, an event end message (i.e., a message indicating the event has ended; e.g., a contest end message) is sent from the real world 100 to the virtual world 90 in accordance with the inter-world protocol 250 at step 445. At step 455, a message from the real world 100 is received at the hosting virtual world server device in the virtual world 90. At step 460, it is checked whether the message from the real world 100 is the event end message or not. If the message is not the event end message, the message is not further considered. If the message is the event end message, at step 465, a winning information object is determined based on a total count value. For example, as shown at a table or database 470, if an object correlator I associated with an information object “Jane” has the highest number of counts (e.g., the highest counter number), then the information object “Jane” is selected as winner in the virtual world 90. In one embodiment, the winner is informed to the real world 100 in accordance with the inter-world protocol 250.

In one embodiment, an event ending decision (i.e., determining whether the event is completed or not) can be made in the virtual world 90. The real world 100 is informed of a winner after counting the number of counts received for objects since an initiation of the event. Though FIGS. 2-4 operates based on that an event (e.g., a contest) is performed in a virtual world 90, it can be understood that FIGS. 2-4 can be applied for auctions, reverse auctions, elections, retail sales, other events in the virtual world 90.

In one embodiment, the contests, auctions, elections, or sales are conducted in a virtual world 90 with interaction with people in a real world 100. People in the real world 100 do not need to be in the virtual world 90 to participate the event and may not even aware that the contests, auctions, elections, or sales are being conducted in the virtual world 90. The objects that are subject of the contests, auctions, elections, or sales can be a real world object (e.g., a car, a house) or a virtual world object (e.g., a virtual weapon). The objects are broadcasted to real world participants in the real world 100 via a communication channel (e.g., television). People in the real world 100 provide feedbacks via the established communication modality, e.g., calling, text messaging, etc. The feedbacks from the real world participants are transmitted to the virtual world 90 in accordance with an inter-world protocol 250 and then used to select a winner of the contests, auctions, elections, or sales in the virtual world.

In another embodiment, if an event (e.g., a contest, an auction, an election, and a sale) is performed in the real world 100, an audience in the virtual world 90 can participate in the event via a real world to virtual world interfacing computer 140 which connects the real world 100 and the virtual world 90, as shown in FIG. 1B. For example, the event in the real world 100 may be broadcasted in the virtual world 90 in a real-time. A feedback (e.g., a vote) from a user in the virtual world 90 may be reflected in the event in the real world 100. As an exemplary embodiment, an email that is sent from a user in the virtual world 90 may be delivered to the real world environment 100 in accordance with the inter-world protocol 250. The email may include a count information (e.g., a table 415). As another exemplary embodiment, a phone call inside the virtual world 90 may be connected to a voting system related to the event in the real world 100. The phone call inside the virtual world 90 may be considered as a valid vote for the event in the real world 100.

It is understood that additional configurations not explicitly illustrated herein are encompassed by the present invention. These configurations include variations of objects that are subject of events (e.g., contests, auctions, elections or sales). These events can occur wholly within a real world, within a virtual world, or within a mixture of both a real world and virtual world(s). An object can be wholly a real world object, wholly a virtual world object, or a mixture of both an object in a real world and an object in virtual world(s).

In one embodiment, the present invention is implemented as hardware on a reconfigurable hardware (e.g., FPGA (Field Programmable Gate Array) or CPLD (Complex Programmable Logic Device)) using a hardware description language (Verilog, VHDL, Handel-C, or System C). In one embodiment, the present invention is implemented on a semiconductor chip (e.g., ASIC (Application-Specific Integrated Circuit)) using a semi custom design methodology (i.e., designing a chip using standard cells and a hardware description language).

In one embodiment, the present invention is implemented as hardware by using a computing device (e.g., a server, a desktop, a laptop, a mainframe, etc.). The computing device comprises, but is not limited to include, an input/output device (e.g., a mouse, a keyboard), a display device (e.g., a monitor), a processor (e.g., Intel® Pentium®, IBM® PowerPC®, etc.), a memory, a storage device, a network interface, etc.

In one embodiment, the present invention is implemented as software using a programming language (e.g., C, C++, Java, .NET, etc.). In one embodiment, the present invention is recorded in a computer recordable medium (e.g., CD (Compact Disk), DVD (Digital Versatile Disc), HDD (Hard Disk Drive)) as an instruction (e.g., machine language or assembly language) that is executed by a processor (e.g., Intel® Pentium®, IBM® Power PC®, AMD® Operon®).

Although the preferred embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application, need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for conducting an event requiring a user participation in a virtual world environment with an interaction by real world participants comprising:
a computer-implemented step for determining an event structure in a virtual world;
a computer-implemented step for identifying at least one information object that can be voted based on the event structure;
a computer-implemented step for creating an information store comprising one or more of: association of an information object with a respective counter and an object correlator assigned to the information object;
a computer-implemented step for sending the at least one information object and corresponding object correlators from the virtual world to the real world;
a computer-implemented step for receiving the at least one information object and the corresponding object correlator in the real world;
a computer-implemented step for broadcasting the at least one information object along with a feedback method;
a computer-implemented step for receiving a feedback from a real world participant via the feedback method, the feedback being associated with an information object among the at least one information object;
a computer-implemented step for sending a count value recorded by the counter in response to the feedback along with a corresponding object correlator from the real world to the virtual world;
a computer-implemented step for receiving the count value and the corresponding object correlator in the virtual world;
a computer-implemented step for associating the count value with an information object by using the corresponding object correlator; and
a computer-implemented step for determining a winner based on a total count value.

2. The method according to claim 1, wherein
the event comprises one or more of: a contest, an auction, an election, and a sale in the virtual world; and
the sending the count value occurs after the contest, auction, election or sale is completed.

3. The method according to claim 2, further comprising:
a computer-implemented step for sending a notification from the virtual world to the real world, the notification comprising one or more of: a contest end message, an auction end message, an election end message, and a sale end message.

4. The method according to claim 2, further comprising:
a computer-implemented step for sending a notification from the real world to the virtual world, the notification comprising one or more of: a contest end message, an auction end message, an election end message, and a sale end message.

5. The method according to claim 1, wherein
the sending the at least one information object and corresponding object correlator from the virtual world to the real world is performed in accordance with an inter-world protocol, the inter-world protocol comprising one or more of: RSS (Really Simple Syndication) feeds, XML (The Extensible Markup Language)-RPC (Remote Procedure Call) protocol, TCP (Transmission Control Protocol), and UDP (User Datagram Protocol); and
the sending a count value recorded by the counter in response to the feedback along with a corresponding object correlator from the real world to the virtual world is performed in accordance with the inter-world protocol.

6. The method according to claim 1, wherein
the information object represents a real world object or a virtual world object; and
the counter reflects the number of feedbacks from real world participants for the information object associated with the counter.

7. The method according to claim 1, wherein
the object correlator is a unique ID (identification) associated with the information object.

8. The method according to claim 1, further comprising:
a computer-implemented step for incrementing the counter associated with the information object that is correlated with the feedback.

9. A system for conducting an event requiring a user participation in a virtual world environment with an interaction by real world participants comprising:
means for determining a event structure in a virtual world;
means for identifying at least one information object that can be voted based on the event structure;
means for creating an information store comprising one or more of: association of an information object with a respective counter and an object correlator assigned to the information object;
means for sending the at least one information object and corresponding object correlator from the virtual world to the real world;
means for receiving the at least one information object and the corresponding object correlator in the real world;
means for broadcasting the at least one information object along with a feedback method;
means for receiving a feedback from a real world participant via the feedback method, the feedback being associated with an information object among the at least one information object;
means for sending a count value recorded by the counter in response to the feedback along with a corresponding object correlator from the real world to the virtual world;
means for receiving the count value and the corresponding object correlator in the virtual world;
means for associating the count value with an information object by using the corresponding object correlator; and
means for determining a winner based on a total count value.

10. The method according to claim 9, wherein
the event comprises one or more of: a contest, an auction, an election, and a sale in the virtual world; and
the means for sending the feedback count is activated after the contest, auction, election or sale are completed.

11. The system according to claim 10, further comprising:
means for sending a notification from the virtual world to the real world, the notification comprising one or more of: a contest end message, an auction end message, an election end message, and a sale end message.

12. The system according to claim 10, further comprising:
means for sending a notification from the real world to the virtual world, the notification comprising one or more of: a contest end message, an auction end message, an election end message, and a sale end message.

13. The system according to claim 9, wherein
the means for sending the at least one information object and corresponding object correlator from the virtual world to the real world is performed in accordance with an inter-world protocol, the inter-world protocol comprising one or more of RSS (Really Simple Syndication) feeds, XML (The Extensible Markup Language)-RPC (Remote Procedure Call) protocol, TCP (Transmission Control Protocol), and UDP (User Datagram Protocol); and
the means for sending a count value recorded by the counter in response to the feedback along with a corresponding object correlator from the real world to the virtual world is performed in accordance with the inter-world protocol.

14. The system according to claim 9, wherein
the information object represents a real world object or a virtual world object; and
the counter reflects the number of feedbacks for the information object associated with the counter.

15. The system according to claim 9, wherein
the object correlator is a unique ID (identification) associated with the information object.

16. The system according to claim 9, further comprising:
means for incrementing the counter associated with the information object that is correlated with the feedback.

17. A computer program product comprising computer usable medium having computer readable program code means embodied therein for conducting an event requiring a user participation in a virtual world environment with an interaction by real world participants, the computer program code means in said computer program product comprising computer readable program code means for causing a computer to effect steps of:
determining an event structure in a virtual world;
identifying at least one information object that can be voted based on the event structure;
creating an information store comprising one or more of: association of an information object with a respective counter and an object correlator assigned to the information object;
sending the at least one information object and corresponding object correlators from the virtual world to the real world;
receiving the at least one information object and the corresponding object correlator in the real world;
broadcasting the at least one information object along with a feedback method;
receiving a feedback from a real world participant via the feedback method, the feedback being associated with an information object among the at least one information object;
sending a count value recorded by the counter in response to the feedback along with a corresponding object correlator from the real world to the virtual world;
receiving the count value and the corresponding object correlator in the virtual world;
associating the count value with an information object by using the corresponding object correlator; and
determining a winner based on a total count value.

18. A computer program storage device, readably by machine, tangibly embodying a program of instructions executable by a machine to perform method steps for conducting an event requiring a user participation in a virtual world environment with an interaction by real world participants, said method steps comprising the steps of;
determining an event structure in a virtual world;
identifying at least one information object that can be voted based on the event structure;
creating an information store comprising one or more of: association of an information object with a respective counter and an object correlator assigned to the information object;
sending the at least one information object and corresponding object correlators from the virtual world to the real world;
receiving the at least one information object and the corresponding object correlator in the real world;
broadcasting the at least one information object along with a feedback method;
receiving a feedback from a real world participant via the feedback method, the feedback being associated with an information object among the at least one information object;
sending a count value recorded by the counter in response to the feedback along with a corresponding object correlator from the real world to the virtual world;
receiving the count value and the corresponding object correlator in the virtual world;
associating the count value with an information object by using the corresponding object correlator; and
determining a winner based on a total count value.
